(19) United States
(12) Patent Application Publication
(10) Pub. No.: US 2012/0137038 A1
(43) Pub. Date: May 31, 2012

(54) ELECTRONIC SYSTEMS SUPPORTING MULTIPLE OPERATION MODES AND OPEARATION METHODS THEREOF

(75) Inventors: Chung-Ching Huang, New Taipei City (TW); Yeh Cho, New Taipei City (TW); Donna Lim, New Taipei City (TW)

(73) Assignee: VIA TECHNOLOGIES, INC., New Taipei City (TW)

(21) Appl. No.: 13/184,345

(22) Filed: Jul. 15, 2011

(30) Foreign Application Priority Data
Nov. 26, 2010 (TW) 99140945

(51) Int. Cl. G06F 13/14

(52) U.S. Cl. 710/303

(57) ABSTRACT

Electronic systems supporting multiple operation modes are provided, wherein the electronic system includes a portable device and a docking system. The portable device at least includes one processing unit and a first operation module, wherein the processing unit includes a plurality of operation frequencies and is operable in a plurality of operation modes, and each operation mode corresponds to an operation frequency. The docking system includes a container for containing the portable device and a second operation module. When the portable device is plugged into the container of the docking system, the portable device receives a signal from the docking system, determines an operation mode of the portable device according to the received signal, adjusts the operation frequency of the processing unit corresponding to the operation mode and selectively applies the first modules or second modules to control the electronic system.

### CROSS REFERENCE TO RELATED APPLICATIONS

This Application claims priority of Taiwan Patent Application No. 099140945, filed on Nov. 26, 2010, the entirety of which is incorporated by reference herein.

### BACKGROUND OF THE INVENTION

1. Field of the Invention

The invention relates to electronic systems and related operation methods, and more particularly, to electronic systems and related operation methods which combine portable devices and docking stations to support a plurality of operation modes.

2. Description of the Related Art

Recently, due to the increased convenience and functions of portable devices, such as mobile phones, smart phones and personal digital assists (PDAs), the devices can be easily carried by users from one place to another when traveling.

The portable devices may perform phone functions, such as telecommunications, SMS messaging, and various other functions. However, because the computing capability for a portable device is generally not enough to perform all functions of a personal computer, users may still require an additional personal computer when computer related functions are required to be performed.

### BRIEF SUMMARY OF THE INVENTION

Electronic systems supporting multiple operation modes and operation methods thereof are provided.

An exemplary embodiment of an electronic system supporting multiple operation modes includes a portable device and a docking system. The portable device at least includes a processing unit and a first operation module, wherein the processing unit includes a plurality of operation frequencies and the portable device is operable in a plurality of operation modes, and each operation mode corresponds to an operation frequency. The docking system includes a container for containing the portable device and a second operation module. When the portable device is plugged into the container of the docking system, the portable device receives a signal from the docking system, determines an operation mode of the portable device according to the received signal, adjusts the operation frequency of the processing unit corresponding to the operation mode and selectively applies the first modules or second modules to control the electronic system.

In another exemplary embodiment, an operation method for use in an electronic system supporting multiple operation modes is provided, wherein the electronic system comprises a portable device comprising at least a processing unit and a first operation module and a docking station comprising a container for containing the portable device and a second operation module, wherein the processing unit includes a plurality of operation frequencies and the portable device is operable in a plurality of operation modes, and each of the operation frequencies correspond to one of the operation modes. The method comprises the following steps. The portable device first receives a signal from the docking station when it is plugged into the container of the docking station. One of the operation modes of the portable device is then determined according to the received signal. Thereafter, one of the operation frequencies of the processing unit which corresponds to the determined operation mode is respectively selected and the first operation module or the second operation module is selectively applied to control the electronic system.

Methods and systems may take the form of a program code embodied in a tangible media. When the program code is loaded into and executed by a machine, the machine becomes an apparatus for practicing the disclosed method.

### BRIEF DESCRIPTION OF THE DRAWINGS

The invention can be more fully understood by reading the subsequent detailed description and examples with reference to the accompanying drawings, wherein:

FIG. 1 is a schematic diagram illustrating an embodiment of an electronic system with multiple operation modes of the invention;

FIG. 2 a schematic diagram illustrating another embodiment of an electronic system with multiple operation modes of the invention;

FIG. 3 is a flowchart of an embodiment of an operation method of the invention; and

FIG. 4 is a flowchart of an embodiment of an operation mode switching method of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

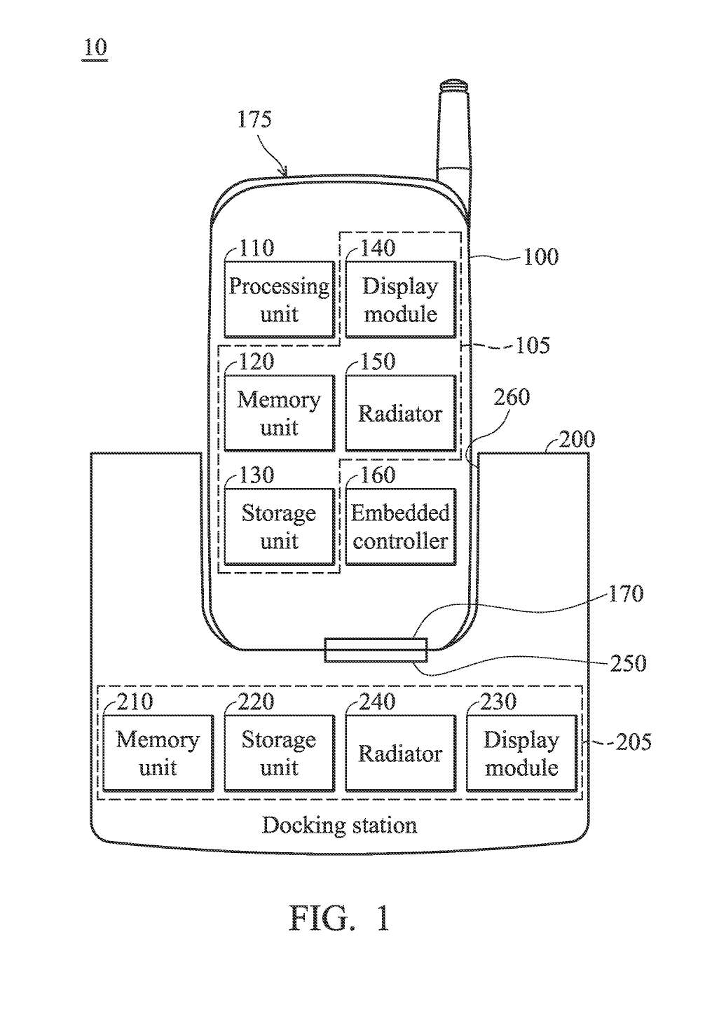

FIG. 1 is a schematic diagram illustrating an embodiment of an electronic system 10 of the invention. The electronic system 10 at least comprises a portable device 100 and a docking station 200. The portable device 100 may comprise a mobile phone. It is to be understood that, the mobile phone is only an embodiment of the portable device 100 of the invention and the invention is not limited thereto.

The portable device 100 may comprise a processing unit 110 and a first operation module 105 (e.g. the first operation module 105 may comprise modules 120, 130, 140 and 150 shown in FIG. 1), wherein the processing unit 110 may include a plurality of operation frequencies and the portable device 100 is operable in a plurality of operation modes, and each of the operation modes corresponding to one of the operation frequencies and a configuration setting. In one embodiment, the aforementioned operation modes at least comprise a first operation mode and a second operation mode and the operation frequencies that correspond thereto are a first operation frequency and a second operation frequency respectively, wherein the first operation frequency is smaller than the second operation frequency. In another embodiment, the first operation mode may be a phone mode with a lower operation frequency, the second operation mode may be a computer mode with a higher operation frequency, and the processing unit 110 may be an x86-based processor.

In some embodiments, the portable device 100 may communicate with communication networks (not shown), such as telecommunication systems. The telecommunication systems may be cellular networks in compliance with various wireless technologies, such as the Global System for Mobile communications (GSM) technology, General Packet Radio Service (GPRS) technology, Enhanced Data rates for Global Evolution (EDGE) technology, Wideband Code Division Multiple Access (WCDMA) technology, Universal Mobile Telecommunications System (UMTS) and others. The portable device 100 may setup a call with another portable device through the communication networks.

The first operation module 105 of the portable device 100 may further comprise a memory unit 120, a storage unit 130, a display module 140 and a radiator 150. In one embodiment, the memory unit 120 may comprise a dynamic random access memory (DRAM) and the storage unit 130 may comprise an SSD memory card, but the invention is not limited thereto. The radiator 150 may provide a heat dissipation function for the processing unit 110. In addition, the portable device 100 may further include an embedded controller 160, which controls architectures of the internal hardware. For example, the embedded controller 160 may comprise a keyboard/mouse controller, but it is not limited thereto. In particular, the embedded controller 160 of the invention may further be utilized to switch the operation modes of the portable device 100 and to switch the operation frequencies of the corresponding operation mode.

In one embodiment, when the portable device 100 is operated in a first operation mode, the operation frequency of the processing unit 110 may be a first operation frequency with low frequency. For example, the first operation mode may be a phone mode and the operation frequency of the processing unit 110 may be reduced from the higher frequency 1.6 GHz to the lower frequency 200 MHz or kept at the original frequency 200 MHz. It is to be noted that, the processing unit 110 is capable of performing all phone-related functions when the operation frequency of the processing unit 110 is set to be 200 MHz.

In another embodiment, when the portable device 100 is operated in a second operation mode, the operation frequency of the processing unit 110 may be a second operation frequency with high operation frequency. For example, the second operation mode may be a computer mode (e.g. desktop computer) and the operation frequency of the processing unit 110 may be set to the maximum operation frequency 1.6 GHz or be over-clocked to exceed 1.6 GHz. It is to be noted that, the processing unit 110 is capable of performing all of computer-related functions when the operation frequency of the processing unit 110 is set to be 1.6 MHz.

In addition to adjusting the operation frequency of the processing unit 110 based on different operation modes, each of the operation modes may comprise a different configuration setting. The configuration settings may at least comprise frequency setting of the display module, setting of the storage device, setting of the memory unit and so on.

The docking station 200 may include a container 260 and a second operation module 205 (e.g. the second operation module 205 may comprise modules 210, 220, 230 and 240 shown in FIG. 1), wherein the container 260 may contain the portable device 100 such that the portable device 100 can be plugged into the container 260 and thus is electrically connected to the docking station 200. When the portable device 100 is plugged into the container 260 of the docking station 200, the portable device 100 receives a signal from the docking station 200, determines an operation mode of the portable device 100 according to the received signal, respectively selects an operation frequency which corresponds to the determined operation mode, and select the first operation module 105 or the second operation module 205 for controlling the electronic system 10. The portable device 100 may directly utilize its own first operation module 105 for operating when operating in the first operation mode while the portable device 100 may utilize the second operation module 205 within the docking station 200 for operating when operating in the second operation mode.

The second operation module 205 of the docking station 200 may further comprise a memory unit 210, a storage unit 220, a display module 230 and a radiator 240. In this embodiment, the second operation module 205 may further include an interface unit 250, wherein the interface unit 250 may transmit signals when electrically connecting to the portable device 100. Signals sent by the docking station 200 may be received by the embedded controller 160 or the interface unit 170. In one embodiment, the interface units 170 and 250 may be, for example, a GPIO interface, but it is not limited thereto. The embedded controller 160 may obtain a mode selection signal of the docking station 200 by detecting the change in the interface unit 170. The operation modes at least comprise a phone mode with a lower operation frequency and a computer mode with a higher operation frequency than the phone mode, wherein the phone and the computer mode can be switched interchangeably by the embedded controller 160. When the portable device 100 is operated in the phone mode, the portable device 100 may perform phone-related functions, such as call functions, sending SMS messages and so on. Similarly, when the portable device 100 is operated in the computer mode, the portable device 100 may perform desktop computer-related functions, such as word processing, audio/video data playing, image processing or the like. The docking station 200 may further comprise a switching button (not shown) and users may manually switch among the operation modes through the switching button. It is to be understood that, when a mode switching operation is performed by the portable device 100, unnecessary modules will be automatically turned off to save power.

In some embodiments, a number of docking stations 200 may be provided and each of which corresponds to one of the operation modes. In this example, after the portable device 100 is plugged into the docking station 200, the docking station 200 may transmit a specific mode selection signal to inform the portable device 100 of the operation mode to switch to. When receiving the specific mode selection signal, the portable device 100 may then switch to a suitable mode and perform responsive resource adjustment and selection accordingly. Therefore, the portable device 100 can be environmental independent and thus can be applied to any environments. In one embodiment, the docking station 200 may be applied to the operation mode for use in a desktop computer. In another embodiment, the docking station 200 may be applied to the operation mode for use in a car. In yet another embodiment, the docking station 200 may be applied to the operation mode for use in home entertainment.

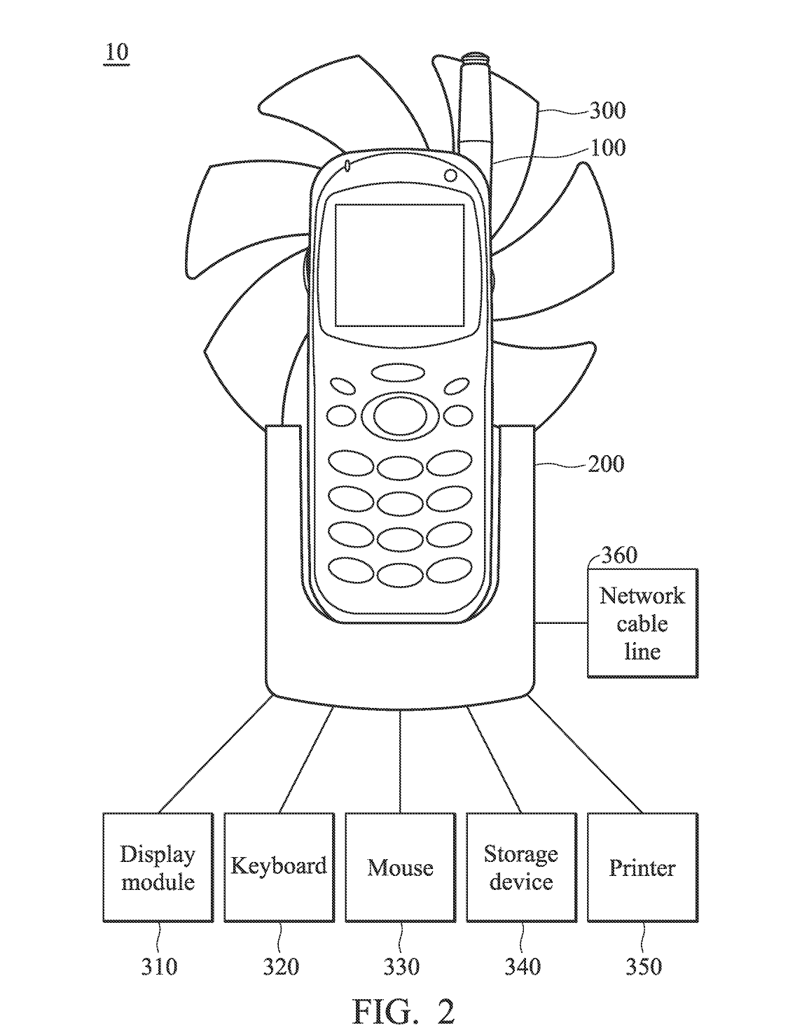

Referring to FIG. 2, the docking station 200 may further connect to a number of peripheral devices, such as a display module 310, a keyboard 320, a mouse 330, a storage device 340 (e.g. external hard disk), a printer 350, and a network cable line 360 capable of connecting to the network and so on. Referring to FIGS. 1 and 2, in some embodiments, the portable device 100 may selectively use its own display module 140 or the display module which is located outside of the portable device 100, such as the external display module 230 on the docking station 200 or the peripheral display device that the docking station 200 is externally connected to (e.g. the display module 310), for display based on the operation mode. In some embodiments, the portable device 100 may selectively use the internal radiator (e.g. the radiator 150 of FIG. 1) or the external radiator (e.g. the radiator 240 of FIG. 1) for heat dissipation based on different operation modes. In addition, to prevent the portable device 100 from overheating, in some specific operation modes (e.g. the computer mode that is operated with a high operation frequency), an external radiator (e.g. a big fan 300) may be further plugged into the docking station 200 to dissipate heat such that the portable device 100 will not shut down due to overheating. In this embodiment, the big fan 300 is located outside of the docking station 200 so that the big fan 300 may provide better heat dissipation for the portable device 100 to efficiently lower the temperature of the portable device 100 after the portable device 100 has been plugged into the docking station 200 so as to prevent the portable device 100 from overheating.

In some embodiments, the portable device 100 may further include a back lid 175, and the back lid 175 of the portable device 100 can be directly taken off to further dissipate heat when it is operated in a specific operation mode that requires higher operation frequency for the processing unit 110. In this situation, in order to prevent the portable device 100 from crashing due to overheating, when operating in the specific operation mode and the back lid has not been taken off, the operation frequency of the processing unit 110 may be reduced to or kept at a lower operation frequency (e.g. 200 MHz) until the back lid of the portable device 100 is taken off or the portable device 100 is plugged into the docking station 200. Operation methods for use in an electronic system 10 will be discussed and detailed below.

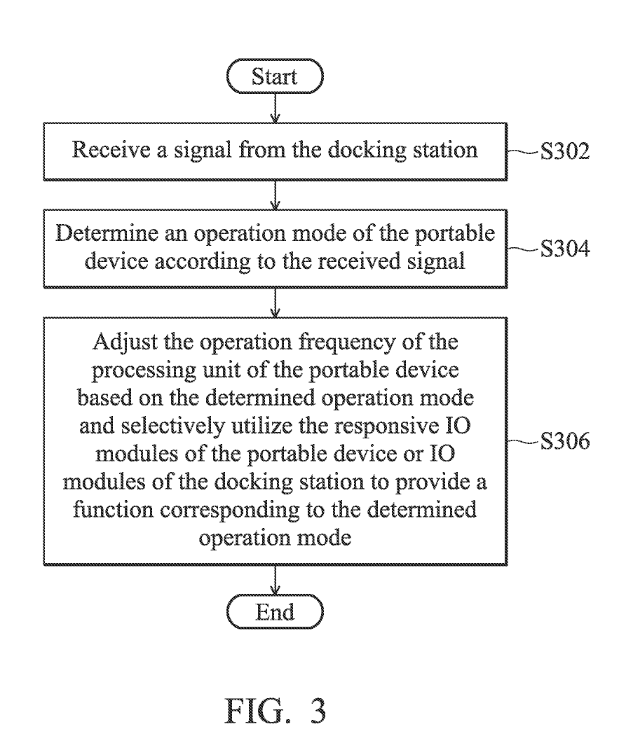

FIG. 3 is a flowchart of an embodiment of an operation method of the invention. Please refer to FIG. 1, FIG. 2 and FIG. 3. In this embodiment, the processing unit 110 may be, for example, an x86-based processor having an operation frequency which can be properly adjusted to perform various functionalities, such as a computer related function that requires operation at a high frequency and a phone related function that requires operation at a lower frequency than the computer related function, but it is not limited thereto.

First, in step S302, the embedded controller 160 of the portable device 100 receives a signal from the docking station 200. Note that the signal may be generated by users by pressing a switching button or the docking station 200 may utilize a fixed pin configuration, such as a fixed GPIO pin configuration, to generate a specific signal. Then, in step S304, the embedded controller 160 determines an operation mode of the portable device 100 according to the received signal. Thereafter, in step S306, the embedded controller 160 adjusts the resource configuration of the portable device 100 based on the determined operation mode and selectively utilizes the responsive IO modules of the portable device 100 or IO modules of the docking station 200 to provide a function that corresponds to the determined operation mode. Adjustment of the resource configuration of the portable device 100 may at least comprise adjustment of the operation frequency of the processing unit 110 to enable the processing unit 110 to provide/perform the function that corresponds to the determined operation mode.

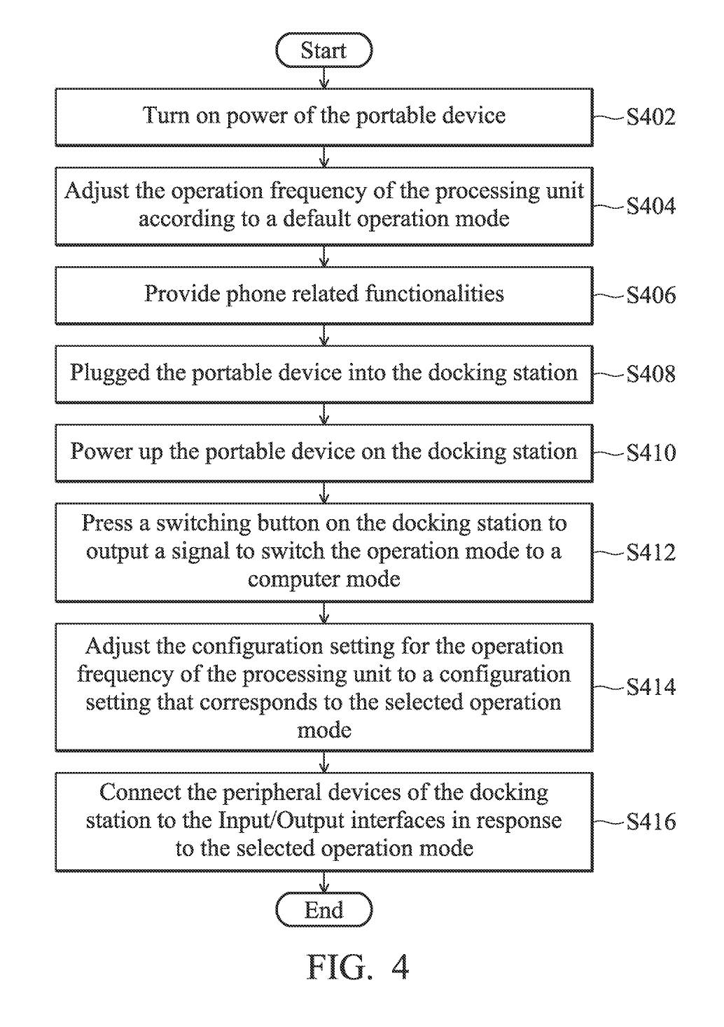

FIG. 4 is a flowchart of an embodiment of an operation mode switching method of the invention. Please refer to FIG. 1, FIG. 2 and FIG. 4. In this embodiment, the operation modes of the portable device 100 at least comprises a first operation mode and a second operation mode, and the portable device 100 may perform phone related functions that require operation at a low operation frequency when operating in the first operation mode or it may perform computer related functions that require operation at a high operation frequency when operating in the second operation mode. First, in step S402, the power of the portable device 100 is turned on and in step S404, the operation frequency of the processing unit 110 is adjusted according to a default operation mode. In this embodiment, as the default operation mode is set to be the first operation mode, the portable device 100 adjusts the operation frequency of the processing unit 110 to a first operation frequency that is capable of performing phone related functions (e.g. 200 MHz), and in step S406, starts to provide phone related functions. That is, the portable device 100 may perform all phone related functions as a normal phone. Thereafter, to switch to the second operation mode capable of providing computed related functions, in step S408, the portable device 100 is plugged into the docking station 200 by the user. Then, in step S410, the portable device 100 is powered up on the docking station 200. In step S412, the switching button on the docking station 200 is pressed so that a signal is generated to indicate that the operation mode is to be switched. Meanwhile, a signal is sent from the docking station 200 to the portable device 100. When receiving the signal, the portable device 100 recognizes that the operation mode is to be switched based on the received signal by the embedded controller 160. Accordingly, in step S414, the embedded controller 160 of the portable device 100 adjusts the configuration setting for the operation frequency of the processing unit 110 to a configuration setting that corresponds to the selected operation mode. Therefore, the embedded controller 160 of the portable device 100 may adjust the operation frequency of the processing unit 110 from the first operation frequency to the second operation frequency, which is capable of performing computer related functions (e.g. raising the operation frequency from 200 MHz to 1.6 GHz). In one embodiment, the embedded controller 160 of the portable device 100 may further determine that at least one external peripheral device (e.g. the modules 310-360 or the fan 300 as shown in FIG. 2) is required to be used, thus, in step S416, the at least one external peripheral device of the docking station 200 is connected to the portable device 100 to serve as IO modules of the portable device 100. Therefore, the portable device 100 can perform computer related functions.

For explanation, one specific embodiment is illustrated in the following to explain the detailed configuration setting processes of the operation modes for use in the electronic system supporting multiple operation modes of the invention, and those skilled in the art will understand that this specific embodiment is used for explanation only and the invention is not limited thereto. In this embodiment, it is assumed that the original configuration setting of the portable device 100 is set as follows: the operation frequency of the processing unit (hereinafter referred to as CPU) is set to be 1.6 GHz, the capacity of the storage unit is set to be SSD 2G (bytes), the capacity of the memory unit (e.g. DRAM) is set to be 2G (bytes), and the frequency of the internal display module is set to be 400 MHz.

In some embodiments, a phone mode is set as the default operation mode so that the operation frequency of the CPU is decreased from 1.6 GHz to the 200 MHz. Also, the capacity of the storage unit is set as the same as the capacity of the internal storage unit 2G (bytes), the capacity of the memory unit is set as the same as the capacity of the internal memory unit 2G (bytes), and the frequency of the internal display module is decreased from 400 MHz to 100 MHz. The size of the display module is about 3-4 inches, and the internal radiator is utilized. Low power consumption and long battery life will be mainly provided when the portable device 100 is operated in the phone mode.

In some embodiments, the operation mode may further comprise a car mode which may provide entertainment or guiding map, wherein the operation frequency of the CPU is decreased from 1.6 GHz to the 800 MHz, the capacity of the storage unit is set as the capacity of the internal storage unit 2G (bytes) plus the capacity of the storage unit in the docking station 200 (e.g. an anti-vibration storage unit dedicated for use in car), the capacity of the memory unit is still set as the same as the capacity of the internal memory unit 2G (bytes), the frequency of the internal display module is set as the same as the maximum frequency 400 MHz for providing audio/video entertainment and game functions, the size of the display module is about 7 inches which is suitable for use in cars, and an external radiator is utilized. When operating in the car mode, a user can plug the portable device 100 into a docking station 200 that is designated for car use only and perform audio/video entertainment and game functions in the car.

In some embodiments, the operation mode may further comprise a desktop computer mode, wherein the operation frequency of the CPU can be set as the maximum frequency 1.6 GHz or be over-clocked to exceed 1.6 GHz, the capacity of the storage unit can be set as the capacity of the internal storage unit SSD 2G (bytes) or as the same as the capacity of the external storage unit in the docking station 200 (e.g. an external SATA hard disk 2.2 TB (bytes)), the capacity of the memory unit is still set as the same as the capacity of the internal memory unit 2G (bytes), the internal display module is turned off while the external independent display module with better display performance than the internal one on the docking station 200 is utilized, the size of the display module is set as the same as the size of the LCD with a size of 23 inches externally connected to the docking station 200, and an external radiator is utilized. When operating in the desktop computer mode, a user can plug the portable device 100 into a docking station 200 that is designated for desktop computer use only such that the combined electronic system can provide all the computer functions and performances needed for the computer.

In some embodiments, the operation mode may further comprise a home entertainment mode, wherein the operation frequency of the CPU can be decreased from 1.6 GHz to 800 MHz, the capacity of the storage unit can be set as the capacity of the internal storage unit SSD 2G (bytes) or as the same as the capacity of the external storage unit in the docking station 200 (e.g. an external USB hard disk 3.0 TB (bytes)) for providing a storage suitable for storing blue-ray audio/video resources, the capacity of the memory unit is still set as the same as the capacity of the internal DRAM with a size of 2G (bytes), the internal display module is turned off while the external independent display module on the docking station 200 (e.g. HDMI) with better display performance than the internal one is utilized, the size of the display module is set as the same as the size of the TV monitor externally connected to the docking station 200 with a size of 42 inches, and an external radiator is utilized. When operating in the home entertainment mode, the user can plug the portable device 100 into a docking station 200 that is designated for home entertainment use only such that the combined electronic system can play video sources with a video quality of 1080p high-definition (HD) and the storage space needed for storing the 1080p high-definition (HD) video sources.

It is to be noted that, for explanation, only a number of modules, devices and peripheral devices are included in the electronic system in the above embodiments, but the invention is not limited thereto. In other words, other kinds of computer peripheral devices and related implemented modules may also be applied to the electronic device supporting multiple operation modes of the invention.

Therefore, according to the electronic systems that support multiple operation modes and operation methods of the invention, a processing unit with high performance is configured on the portable device and an operation mode of the portable device is determined based on a docking station such that the portable device may comprise a number of different functionalities such as a phone function and a personal computer function, thus simplifying hardware architecture, reducing required hardware space and efficiently saving hardware cost. Moreover, peripheral devices which are configured internally or externally may further be selectively combined and utilized based on the operated environment requirement to achieve a goal for supporting multiple functions within one device. Furthermore, the electronic systems that support multiple operation modes of the invention may further provide built-in or external radiators to provide a heat dissipation mechanism for processing units which are operating at high speeds so that the portable device may be prevented from overheating, enabling the portable device to successfully operate in various kinds of environments.

Systems and methods thereof, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic system supporting multiple operation modes, comprising:
a portable device, comprising at least a processing unit and a first operation module, wherein the processing unit includes a plurality of operation frequencies and the portable device is operable in a plurality of operation modes, and each of the operation frequencies correspond to one of the operation modes; and
a docking station, comprising a container for containing the portable device and a second operation module;
wherein when the portable device is plugged into the container of the docking station, the portable device receives a signal from the docking station, determines one of the operation modes of the portable device according to the received signal, respectively selects one of the operation frequencies of the processing unit which corresponds to the determined operation mode, and selectively applies the first operation module or the second operation module to control the electronic system.

2. The electronic system as claimed in claim 1, wherein the portable device further comprises an embedded controller for receiving the signal to switch the determined operation mode to one of the operation modes of the portable device.

3. The electronic system as claimed in claim 1, wherein the docking station further comprises a switching button for generating the signal to select one of the operation modes of the portable device.

4. The electronic system as claimed in claim 1, wherein the operation mode comprises a first operation mode and a second operation mode, and the operation frequencies which the first operation mode and the second operation mode correspond to are a first operation frequency and a second operation frequency respectively, wherein the first operation frequency is smaller than the second operation frequency.

5. The electronic system as claimed in claim 4, wherein the first operation mode has a phone-related function and the second operation mode has a computer-related function, and the processing unit comprises an x86-based processor.

6. The electronic system as claimed in claim 1, wherein the first operation module of the portable device further comprises a first interface unit and the second operation module of the docking station further comprises a second interface unit, wherein the first interface unit is used for receiving the signal transmitted by the second interface unit when the portable device and the docking station are connected.

7. The electronic system as claimed in claim 1, wherein the docking station further connects to at least one external peripheral device.

8. The electronic system as claimed in claim 1, wherein the portable device further selects to utilize a display module within the portable device or another display module which is located outside of the portable device for display based on the signal.

9. The electronic system as claimed in claim 1, wherein the portable device further selects to utilize a storage unit within the portable device or another storage unit which is located outside of the portable device for accessing data based on the signal.

10. The electronic system as claimed in claim 1, wherein the portable device further selects to utilize a radiator within the portable device or another radiator which is located outside of the portable device for heat dissipation based on the signal.

11. The electronic system as claimed in claim 1, wherein the portable device further comprises a back lid, and the back lid of the portable device further be taken off to dissipate heat when operating in a specific operation mode.

12. An operation method for use in an electronic system supporting multiple operation modes, wherein the electronic system comprises a portable device comprising at least a processing unit and a first operation module and a docking station comprising a container for containing the portable device and a second operation module, wherein the processing unit includes a plurality of operation frequencies and the portable device is operable in a plurality of operation modes, and each of the operation frequencies correspond to one of the operation modes, comprising:
receiving a signal from the docking station, by a portable device, when the portable device is plugged into the container of the docking station;
determining one of the operation modes of the portable device according to the received signal; and
selecting one of the operation frequencies of the processing unit which respectfully corresponds to the determined operation mode and selectively applying the first operation module or the second operation module to control the electronic system.

13. The operation method as claimed in claim 12, wherein the portable device further comprises an embedded controller for receiving the signal to switch the operation mode to one of the operation modes of the portable device.

14. The operation method as claimed in claim 12, wherein the docking station further comprises a switching button for generating the signal to select one of the operation modes of the portable device.

15. The operation method as claimed in claim 12, wherein the operation mode comprises a first operation mode and a second operation mode, and the operation frequencies which the first operation mode and the second operation mode correspond to are a first operation frequency and a second operation frequency respectively, wherein the first operation frequency is smaller than the second operation frequency.

16. The operation method as claimed in claim 12, wherein the docking station further connects to at least one external peripheral device, and the method further comprises:
connecting to the at least one external peripheral device according to the signal when operating in a specific operation mode of the operation modes.
